(19) United States
(12) Patent Application Publication
(10) Pub. No.: US 2026/0090674 A1
(43) Pub. Date: Apr. 2, 2026

(54) HEAT DISTRIBUTOR FOR A BARBECUE GRILL

(71) Applicant: ACEWILL CORPORATION, Apia (WS)

(72) Inventor: Kiosky Chung, Taichung City (TW)

(21) Appl. No.: 18/900,859

(22) Filed: Sep. 29, 2024

(51) Int. Cl. A47J 37/07; F24B 1/189

(52) U.S. Cl. CPC A47J 37/0704; A47J 37/0786; F24B 1/189

(57) ABSTRACT

A barbecue grill includes a heat source unit and a cooking unit. The cooking unit includes a heat distributor located below a grid. The heat distributor includes a roof located below the grid, two walls located below and on two opposite sides of the roof, and a gap between the roof and each of the walls. Each of the gaps gets wider as it extends from the heat source.

### BACKGROUND OF INVENTION

### 1. Field of Invention

The present invention related to a barbecue grill and, more particularly, to a heat distributor for a barbecue grill.

### 2. Related Prior Art

U.S. Pat. No. 11,172,688, FIG. 7, discloses a gravity fed smoker including a smoke tunnel 86 located below a grid. The smoke tunnel 86 consists of a top and two walls. Each of the walls includes openings 88. The openings 88 are arranged along the smoke tunnel 86. The openings 88 get bigger toward an outlet of the smoke tunnel 86 from an inlet 92 of the smoke tunnel 86. In operation, smoke is introduced into the smoke tunnel 86 via the inlet 92. Then, the smoke leaves the travel tunnel 86 through the openings 88 as the smoke travels toward the outlet from the inlet 92 along the smoke tunnel 86. The smoke inevitably gets cooler as it travels toward the outlet from the inlet 92. For compensation, more of the smoke travels to the grid from the smoke tunnel 86 via the last openings 88 than through the first openings 88. Thus, temperature is expected to be constant over the grid. However, it requires a specific mold to punch each of the walls to provide the openings 88. Hence, the making of the smoke tunnel 86 is complicated and the cost of the smoke tunnel 86 is high.

The present invention is therefore intended to obviate or at least alleviate the problems encountered in the prior art.

### SUMMARY OF INVENTION

It is the primary objective of the present invention to provide a barbecue grill with an inexpensive heat distributor.

To achieve the foregoing objective, the heat distributor includes a roof located between two walls. There is a gap between the roof and each of the walls. Each of the gaps gets wider as it extends from the heat source unit.

In another aspect, each of the walls is formed with a height getting small as it extends from the heat source unit.

Other objectives, advantages and features of the present invention will be apparent from the following description referring to the attached drawings.

### BRIEF DESCRIPTION OF DRAWINGS

The present invention will be described in detail with reference to the drawings wherein:

FIG. 1 is a perspective view of a barbecue grill equipped with a heat distributor in accordance with the preferred embodiment of the present invention; and

FIG. 2 is a partial and cut-away view of the barbecue grill shown in FIG. 1.

### DETAILED DESCRIPTION OF PREFERRED EMBODIMENT

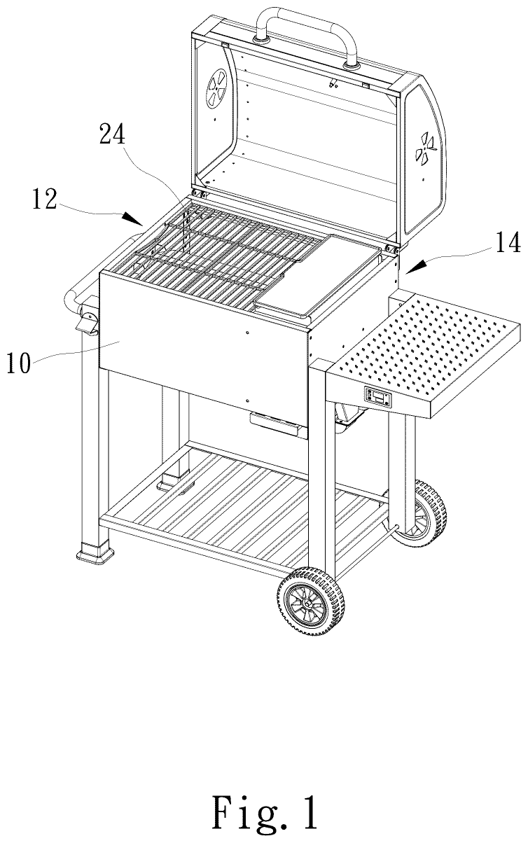

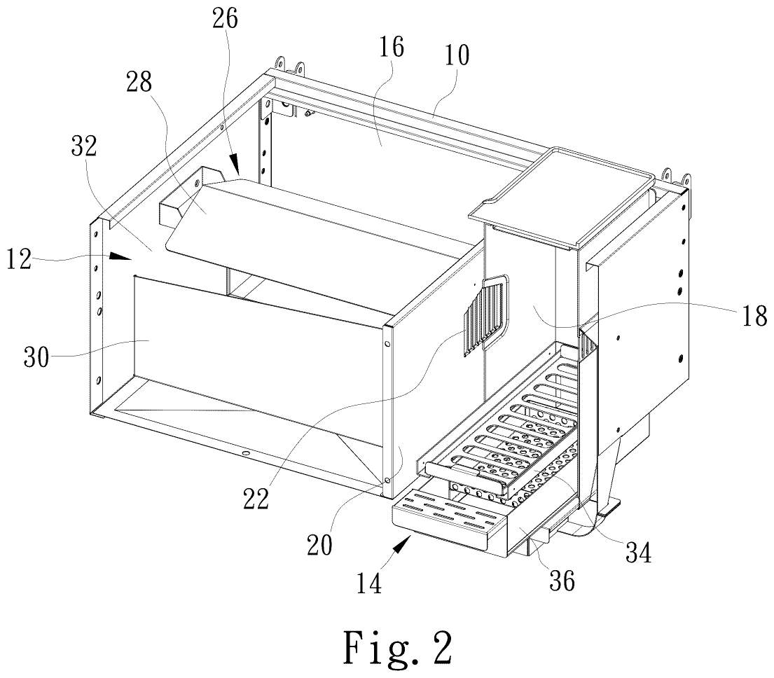

Referring to FIGS. 1 and 2, a barbecue grill includes a bowl 10, a cooking unit 12 and a heat source unit 14 according to the preferred embodiment of the present invention. The bowl 10 includes two compartments 16 and 18 separated from each other by a partition 20. The partition 20 includes an orifice 22 via which the compartments 16 and 18 are in communication with each other. The cooking unit 12 is located in the compartment 16. The heat source unit 14 is located in the compartment 18.

The heat cooking unit 12 includes a grid 24 and a heat distributor 26. The grid 24 is located on the bowl 10, over the compartment 16. The grid 24 is replaceable with a pan or any other proper element capable of supporting food materials. The heat distributor 26 located in the compartment 16, below the grid 24.

The heat distributor 26 includes a roof 28 located above and between two walls 30. The roof 28 and the walls 30 of the heat distributor 26 and a bottom plate (not numbered) of the bowl 10 together provide a tunnel (not numbered) in communication with the compartment 18 via the aperture 22 including an inlet (not numbered) and an outlet (nut numbered). The inlet is located closer to the aperture 22 than the outlet is.

There is a gap 32 between the roof 28 and each of the walls 30. The height of each of the walls 30 gets smaller as the walls 30 extend toward the outlet from the inlet. Thus, each of the gaps 30 gets wider as it extends toward the outlet from the inlet.

The heat source unit 14 includes a coal grid 34 and an ash tray 36. The coal grid 34 is located above the ash tray 36. Although not shown, a blower is used to send air into the compartment 18.

In operation, coal (not shown) is located on the coal grid 34. The coal is burned to heat the air in the compartment 18. The ash tray 36 receives ash from the coal grid 34. The heated air is introduced into the tunnel from the compartment 18 via the orifice 20. Most of the heated air leaves the tunnel via the gaps 30 as the heated air travels toward the outlet from the inlet along the tunnel. Finally, some of the heated air leaves the tunnel via the outlet. More of the heated air travels to the grid 24 from the tunnel via the gaps 30 in vicinity of the outlet than in vicinity of the inlet. Thus, temperature is constant over the grid 24.

Advantageously, it does not require any specific mold to punch each of the walls 30 with openings via which the heated air leaves the tunnel for the grid 24. Hence, the making of the heat distributor 26 is simple and the cost of the heat distributor 26 is low.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A barbecue grill comprising:
a heat source unit; and
a cooking unit comprising a grid and a heat distributor located below the grid, wherein the heat distributor comprises a roof located below the grid, two walls located below and on two opposite sides of the roof, and a gap between the roof and each of the walls, wherein each of the gaps gets wider as it extends from the heat source.

2. The barbecue grill according to claim 1, wherein each of the walls is formed with a height getting small as it extends from the heat source unit.
